(19) United States
(12) Patent Application Publication
(10) Pub. No.: US 2005/0091378 A1
(43) Pub. Date: Apr. 28, 2005

(54) Method and system for using mobile code to measure quality of service over a network

(76) Inventor: Jorg Nonnenmacher, Valbonne (FR)

Correspondence Address: BROWN, RAYSMAN, MILLSTEIN, FELDER & STEINER LLP, 900 THIRD AVENUE, NEW YORK, NY, 10022, US

(21) Appl. No.: 10/777,775

(22) Filed: Feb. 12, 2004

Related U.S. Application Data
(63) Continuation of application No. 09/546,130, filed on Apr. 10, 2000, now abandoned.

(51) Int. Cl. G06F 15/16

(52) U.S. Cl. 709/227

(57) ABSTRACT

The invention is a method for using mobile code such as an applet to conduct quality of service measurements of network paths in client applications such as web browsers. A client computer downloads the mobile code from a base server as well as a list of target host URLs from the base server. When executed, the mobile code accesses each of the target URLs and measures quality of service (QoS) data such as round-trip time, delays, loss of packets, etc. for each URL. The mobile code compiles this QoS data and transmits it back to the base server for processing and analysis. The base server may then transmit a second set of target URLs, which set may be generated randomly, previously selected, or selected based upon the QoS data received from the mobile code. In addition, the client may use the QoS measurements to determine which of the target URLs represents the better or best path of communications for the client, and may re-establish communications over that path accordingly. When many clients retrieve and run the mobile code and send QoS results back to the base server, the base server will eventually compile a comprehensive set of QoS statistics for widespread Internet traffic in a cost-effective and efficient manner.

### CROSS REFERENCE TO RELATED APPLICATION

This is a continuation of application Ser. No. 09/546,130, filed Apr. 10, 2000, now pending.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

The invention disclosed herein relates generally to network management and quality control. More particularly, the present invention relates to methods for measuring quality of service over a network such as the Internet.

Several software tools are in use which track paths and characteristics of data flow over a network such as the Internet. For example, the widely available program called PING allows a host computer to send an ICMP packet towards a specified destination. From the time between the sending of the ICMP packet and the reply of a host/router on the path to the destination, the round-trip time to this host/router can be calculated. Successive PING commands issued by the host computer to different computers can thus allow a comparison of the data retrieval times to different computers.

Another frequently used program called TRACEROUTE traces and outputs the path in which data packets travel over the Internet, including names of servers and routers, between a host computer issuing the TRACEROUTE command to a designated second computer. Yet a third software tool called PATHCHAR estimates the bandwidth, time delay, average queue, and loss rate of a communication between a source computer issuing a PATHCHAR command and a designated destination computer.

These tools allow users of a host computer to conduct some analysis of that computer's connections with others over the network. However, a more comprehensive analysis of traffic over the Internet would require the establishment and maintenance of a number of dedicated host computers each set up with the proper tools. Indeed, the use of these conventional tools would generally require the setup and administration of n dedicated computers to obtain n*n path characteristics. Unfortunately, the setup and maintenance of this many dedicated sites quickly becomes a very costly project by which to obtain a meaningful set of results.

A very comprehensive analysis of Internet traffic is clearly desirable to help select the most efficient pathways for data transmission. Moreover, a comprehensive analysis of the quality of service of Internet traffic is important if not essential for Internet telephony and related applications.

There is thus a need for methods and systems for more efficiently gathering comprehensive quality of service data for networks such as the Internet.

### BRIEF SUMMARY OF THE INVENTION

In accordance with the present invention, these and other problems are solved by using mobile code such as applets or controls to conduct quality of service measurements of network paths in client applications such as web browsers. A client computer downloads the mobile code from a base server as well as a list of target host uniform resource locators or URLs from the base server. The list of target URLs may be downloaded with the mobile code or in response to a request from the mobile code executing in the client's browser.

When executed, the mobile code accesses each of the target URLs and measures quality of service (QoS) data such as transmission time, delays, loss of packets, etc. for each URL. The mobile code compiles this QoS data and transmits it back to the base server for processing and analysis. The base server may then transmit a second set of target URLs, which set may be generated randomly, previously selected, or selected based upon the first set of target URLs, other target URLs generated for other client computers, or QoS data received from the mobile code from this or other client computers. In addition, the client may use the QoS measurements to determine which of the target URLs represents the better or best path of communications for the client, and may re-establish communications over that path accordingly.

Because many clients may retrieve and run the mobile code and send results back to the base server, the base server will eventually compile a comprehensive set of QoS statistics for widespread Internet traffic in a cost-effective and efficient manner. In addition, the operation of the mobile code within client applications such as web browsers allows for QoS measurements to be performed behind firewalls.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram of an exemplary system using mobile code for targeted measuring quality of service over the Internet;

FIG. 2 is a flow chart showing an exemplary process performed in the system of FIG. 1 for measuring quality of service over the Internet;

FIG. 3 is a flow diagram illustrating a timing arrangement achieved in performing multiple round-trip time measurements in series; and

FIGS. 4 and 5 are flow diagrams illustrating timing arrangements achieved in performing multiple round-trip time measurements in parallel.

### DETAILED DESCRIPTION OF THE PREFERRED EMBODIMENTS

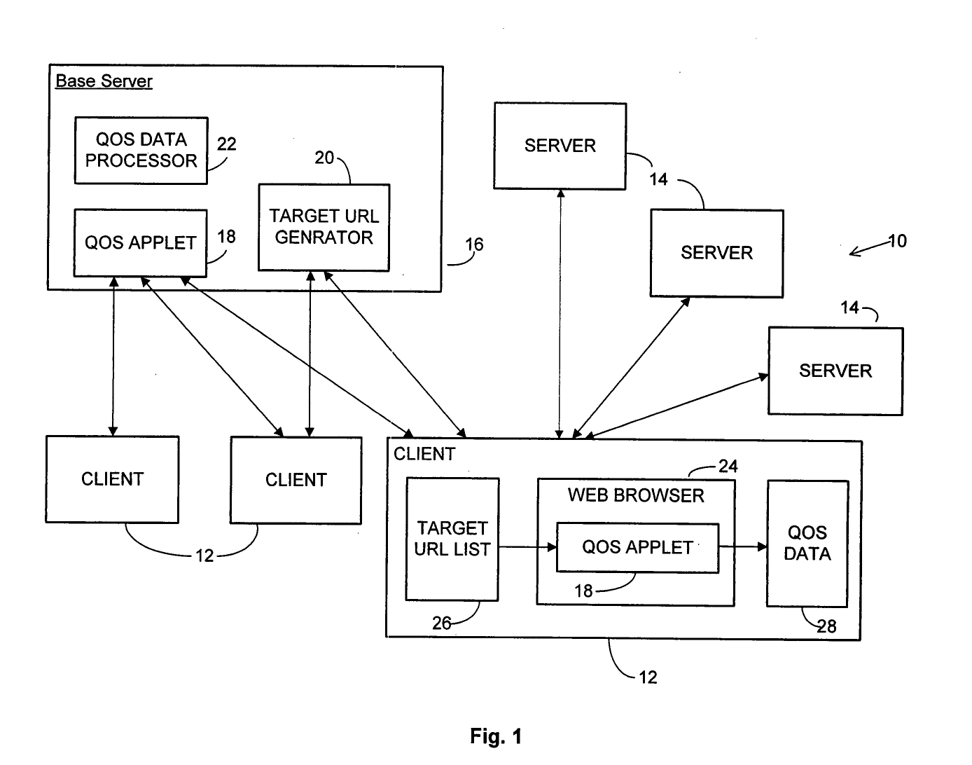

With reference to FIG. 1, one preferred embodiment of a system of the present invention is implemented in a client/server network 10 such as an internal network, a wide-area network or the Internet. The network 10 includes a large number of clients 12 and a large number of servers 14, one of which is a base server 16. In the embodiment shown in FIG. 1, the clients 12 and servers 14, 16 communicate via HTTP or other protocols used on the world wide web.

The base server 16 stores a Java applet 18 used for measuring quality of service parameters in communications between computers over the network 10, a module 20 for generating target URLs, and a module 22 for processing quality of service data collected from the clients 12. The Java applet 18 is executable in a Java virtual machine embedded on a web browser 24 residing on the client 12, such as Netscape COMMUNICATOR or Microsoft INTERNET EXPLORER. The applet 18 can work on top of TCP only, on HTTP/TCP, or on top of other protocols such as UDP, ICMP, or RTCP.

The target URL generator module 20 is a software routine which generates lists of URLs of target servers, one such target URL list 26 being shown after receipt and storage on the client 12. Factors considered in the selection of target URLs by the generator module 20 are described in greater detail below.

As explained further below, the applet 18 executing within the web browser 24 measures quality of service parameters for communications between the client 12 upon which the applet 18 is running and each of the servers 14 in the target URL list 26. The resulting QoS data set 28 is then returned to the base server 16 for processing with other similarly retrieved QoS data by the QoS data processor 22.

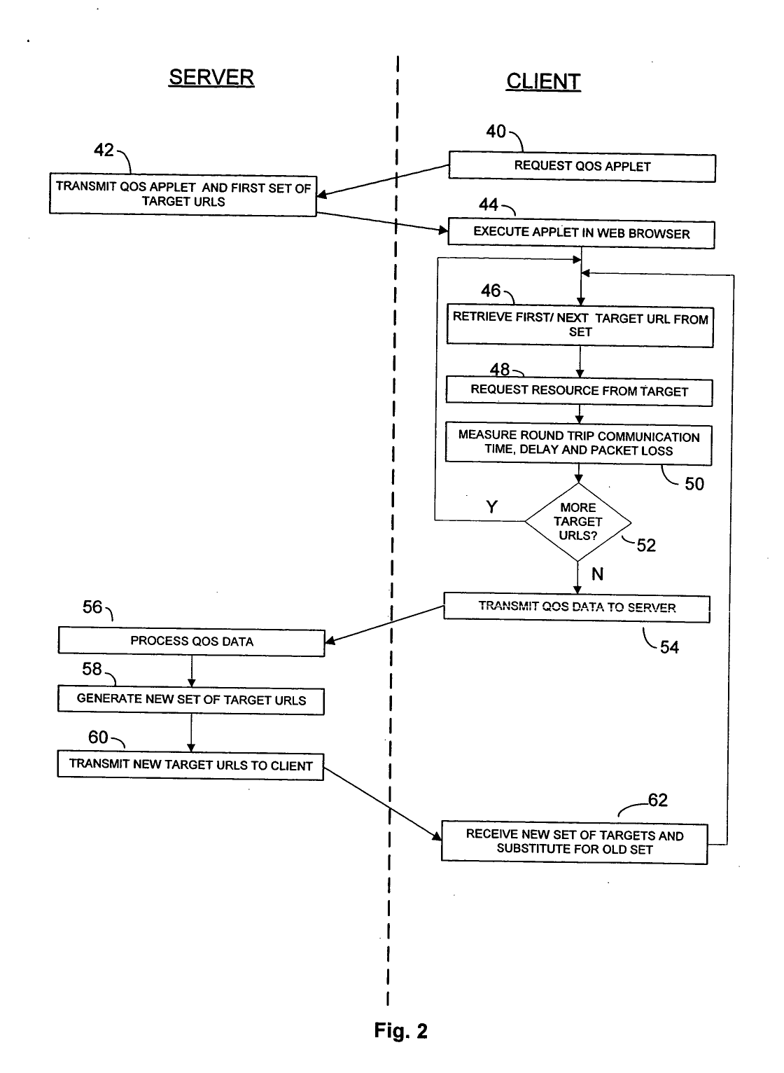

A process performed by the system of FIG. 1 in accordance with one embodiment is shown in FIG. 2. Any given client may request the applet, step 40, by, for example, requesting a resource located by a specific URL on the base server, which resource incorporates the applet. The base server receives the request and transmits the applet with a first set of target URLs to the client, step 42. Alternatively, the server may initially transmit only the applet, which applet then contacts the base server and transmits a request for the list of target URLs, at which point the base server transmits the target URL list to the client to be loaded in the client.

The first list of target URLs may be predetermined, generated randomly, or selected based upon the IP address of the client requesting the list. In some embodiments, the list of target URLs is generated to control the load on the target servers 14. That is, the selection of the target URLs for a given instance determines and controls the load for each of the target servers 14 during the measurement process. The base server 16 thus serves as a central instance controlling load across the target servers 14, and accounts for the given allowed load on each of the target servers 14. The selection of target URLs also allows the base server 16 to exclude certain target servers 14 from measurement. In general, target URL selection takes into account other factors or data such as a previous measurement load, an allowed load, the time, and the location.

In any event, the client executes the applet within the web browser, step 44. The applet retrieves the set of target URLs, step 46, either from a storage device on the client or by issuing a request to the base server. For each URL in the list, the applet retrieves the URL, step 46, and attempts to establish communication with the target server, step 48. In one embodiment, the applet tries to access and retrieve randomly names files on the target servers identified in the list. The applet measures various quality of service parameters during the communication with the target server, step 50, including round trip retrieval times for each file retrieved from the server, packet loss inferred from TCP timeouts which occur during data retrieval, delays, etc. The applet performs these measurements using techniques known to those of skill in the art and implemented for example, in the PING, TRACEROUTE, and PATHCHAR programs discussed above.

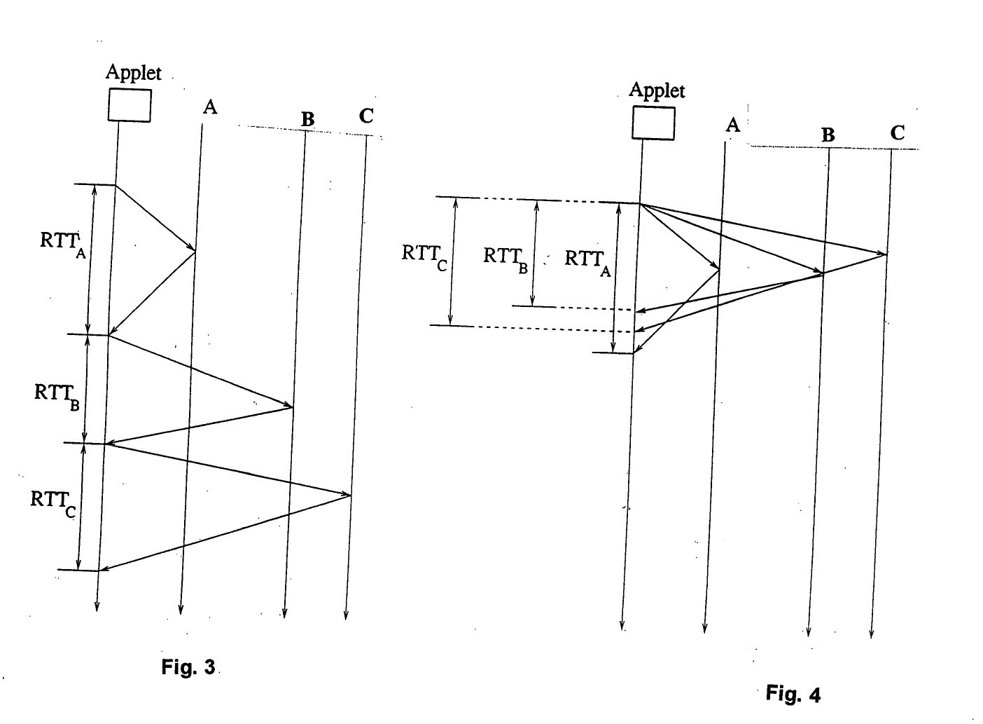

This process is repeated for each target server identified in the list. As described further below with reference to FIGS. 3, 4 and 5, the process of performing measurements may be repeated serially for each target server or performed in parallel by the applet. When there are no more URLs in the list, step 52, the measured QoS data is transmitted to the base server, step 54. Alternatively, data representing each measurement may be transmitted to the server upon measurement thereof. In any event, the base server receives and processes the QoS data, step 56, to thereby analyze the data in whatever fashion may be desired. Examples of processing include correlation of geographic distance to round-trip time and classification of Internet access connections dependent on provider, country, time of day, continent, and special events. One skilled in the art will recognize that the QoS data may be used in numerous other analyses to discover desired useful information.

The base server then generates a new list of target URLs, step 58, either by selecting the URLs according to a predetermined order, randomly, to balance load, or based upon its analysis of previously received QoS data such as the QoS data just received from the client. Factors used in generating the new list are described above. The new target URL list is transmitted to the client, step 60, which receives it and substitutes it for the existing set, step 62. Alternatively, the base server generates and transmits the new target URL list only in response to a request for the list by the applet, or only after determining according to predetermined rules whether to continue taking QoS measurements from this client.

In addition, in some embodiments the client uses the measured QoS data to determine the best target to employ based on QoS factors. For example, the target URL list may represent a set of target servers from which a desired resource may be retrieved, and the measurements taken by the applet are used to select one of the target servers from to actually retrieve the resource. The base server may generate such target URL lists for various resources available over the network and allow clients to select which target list they desire to conduct measurements on.

As explained above, the applet may take its round-trip time and other measurements in series, e.g., one target server at a time, or in parallel. A diagram illustrating the timing for series measurements is shown in FIG. 3. The measurements are performed by the applet against target servers A, B, and C, where RTTₓ represents the round-trip time from the applet to server x. Since the machine or host on which the applet executes and which acts as the access link sends the packets faster than the network can transport them to and from the target server, the resulting queuing increases or biases the round-trip times. This queuing is illustrated in FIG. 3.

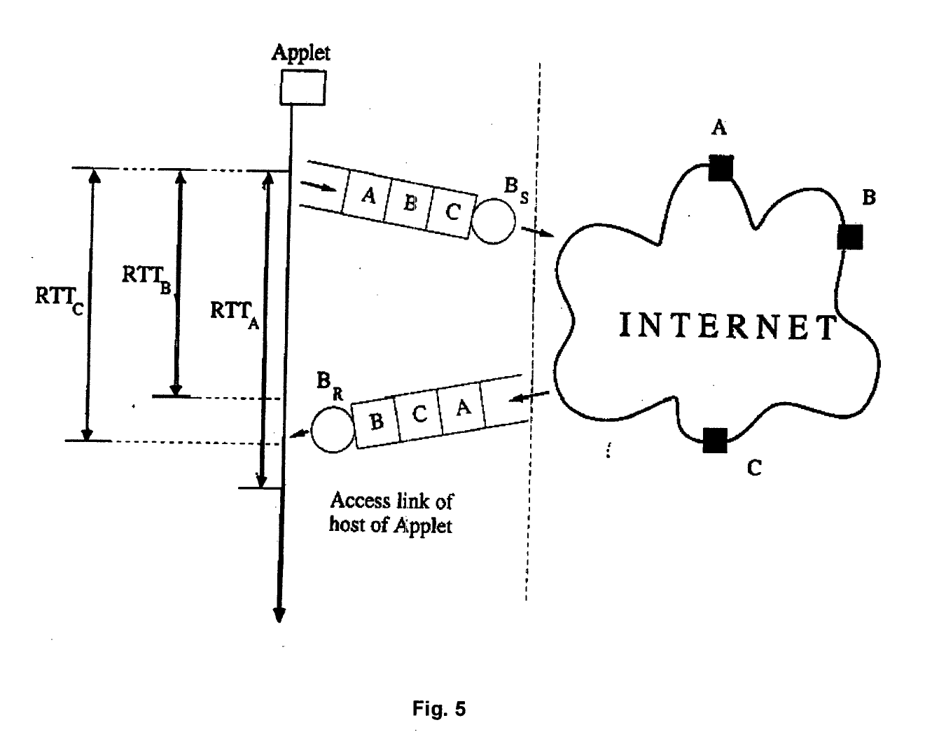

FIGS. 4 and 5, on the other hand, illustrate how executing measurements in parallel avoids queuing at the access link. As shown in FIG. 4, measurement packets sent out to all target servers at the same time are returned at different times, with all round-trip times being discernible. As shown in FIG. 5, a queue of packets ABC is sent to destination servers A, B, and C connected to the Internet. The sequence and timing in which the packets are returned allows the applet and its host to determine the round-trip times RTT_{A}, RTT_{B} and RTT_{C}.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

1. A method for measuring quality of service over a network, the method comprising:
transmitting from a server to a client a mobile program and a plurality of first identifiers representing a plurality of first target hosts accessible to the client over the network, the mobile code being executable in a client application and capable of measuring one or more quality of service parameters of communications between the client and each of the first target hosts; and
receiving at the server from the mobile program data representing a plurality of quality of service parameters measured by the mobile program from communications between the client and the first target hosts.
